(19) United States
(12) Patent Application Publication
(10) Pub. No.: US 2002/0172931 A1
(43) Pub. Date: Nov. 21, 2002

(54) Apparatus, system and method for remote monitoring of testing environments

(75) Inventors: David Perry Greene, Ossining, NY (US); Edith Helen Stern, Yorktown Heights, NY (US); Barry Edward Willner, Briarcliff Manor, NY (US); Philip Shi-Lung Yu, Chappagua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/860,752

(22) Filed: May 18, 2001

(51) Int. Cl. G09B 3/00; G09B 7/00

(52) U.S. Cl. 434/322

(57) ABSTRACT

An apparatus, system and method for monitoring testing environments from a remote location are provided. More specifically, a mechanism for proctoring tests to users from a remote location as a test administration service is provided. With this mechanism, test environment data is obtained from sensor devices in the user's testing environment and forwarded to a proctor workstation. A human proctor may monitor the user's test environment to determine if cheating is taking place. The testing environment data may be recorded along with test input data from the user's client device for later use should cheating be suspected. Moreover, the administering of the test may be done by a third party as a test administration service to which a test developer may subscribe. Alternatively, the users of the test administration service may be billed for their individual use of the test administration service.

### BACKGROUND OF THE INVENTION

1. Technical Field

The present invention is directed to an improved data processing system. More specifically, the present invention is directed to an apparatus, system and method for remote monitoring of testing environments.

2. Description of Related Art

On-line testing is becoming more prevalent as users of data networks realize the potential to obtain training and education via electronic means. Many colleges and universities are beginning to offer classes via computer networks, such as the Internet. With such classes, a user may download a previously recorded lecture or receive a audio/video feed of a live lecture through the user's home computer system. In this way, the student need not be physically located in the lecture location to obtain the benefit of the teacher's instruction.

In addition, some educational institutions are providing students with the ability to take tests via their home computer and a data network. With such “on-line” testing, typically the student is able to download a copy of the test, take the test, and provide his/her answers to the instructor by uploading the answers to the instructor's computer system. Thus, the student takes the test under the “honor” system. That is, there is no supervision of the student's testing environment to make sure that the student has not cheated on the test.

Moreover, each educational institution must provide storage space and bandwidth on their network to allow teachers to post tests on the network for download by the students. In larger universities, where classes may sometimes exceed 500 or more students, and many classes offer on-line testing at the same time (such as at mid-terms or final exam time), this may cause problems with the university's network. Furthermore, if the university's network experiences problems, some students may not be able to obtain the tests or upload their answers.

Therefore, it would be beneficial to have an apparatus, system and method by which a student's testing environment can be monitored from a remote location in order to make sure that the student does not receive unauthorized assistance during an examination. Moreover, it would be beneficial to have an apparatus, system and method by which proctoring of an on-line test may be outsourced to a third party that is capable of proctoring the exam from a remote location.

### SUMMARY OF THE INVENTION

The present invention provides an apparatus, system and method for monitoring testing environments from a remote location. More specifically, the present invention provides a mechanism by which tests may be proctored to users from a remote location as a test administration service. With the present invention, test environment data is obtained from sensor devices in the user's testing environment and forwarded to a proctor workstation. A human proctor may monitor the user's test environment to determine if cheating is taking place. The testing environment data may be recorded along with test input data from the user's client device for later use should cheating be suspected. Moreover, the administering of the test may be done by a third party as a test administration service to which a test developer may subscribe. Alternatively, the users of the test administration service may be billed for their individual use of the test administration service. Other features of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a network data processing system in which the present invention may be implemented;

FIG. 2 is an exemplary block diagram of a server in accordance with the present invention;

FIG. 3 is an exemplary block diagram of a client device in accordance with the present invention;

FIG. 4 is an exemplary block diagram of the primary components of the automated test proctoring system according to the present invention;

FIG. 5 is an example screen of a test proctor workstation in accordance with the present invention; and

FIG. 6 is a flowchart outlining an exemplary operation of the present invention.

### DETAILED DESCRIPTION OF THE PREFERRED EMBODIMENT

FIG. 1 is an exemplary diagram of a distributed data processing system in accordance with the present invention. As shown in FIG. 1, the distributed data processing system 100 includes a plurality of client devices 108, 111 and 114 coupled to at least one network 102. In addition, the network 102 is coupled to a test developer system 101 and a test administration system 103. The test developer system 101 may be used to develop a test to be administered by the test administration system 103. Client devices 108, 111, and 114 may log onto the test administration system 103 so that users of the client devices 108, 111 and 114 maybe administered the test developed by the test developer system 101.

The test developer system 101 and the test administration system 103 may be operated by the same or different entities. For example, the test developer system 101 may be a computer system associated with an institution interested in testing individuals. For example, the test developer system 101 may be a computer system associated with a college, university, corporation or other business entity, government agency, or the like. The test that is to be administered to the individuals may be developed using the test developer system 101 or the test developer system 101 may simply be used as a means by which the test is transferred to the test administration system 103.

The test administration system 103 may be operated by the same or a different entity from that of the test developer system 101. Thus, for example, the college, university, corporation or other business entity, government agency, or the like, that operates the test developer system 101 may also operate the test administration system 103. Alternatively, the test administration system 103 may be operated by a third party who is contracted by the operator of the test developer system 101 to administer their test.

The test administration system 103 has at least one central server 104 that is used to send and receive testing and monitoring information to and from the client devices 108, 111 and 114 and the proctor workstations 105-107. The proctor workstations 105-107 are used to monitor individuals taking tests administered by the test administration system 103. The proctor workstations 105-107 receive monitoring information from the client devices 108, 111, and 114, and are able to perform various functions in response to a human proctor's input, as will be described in more detail hereafter.

The client devices 108, 111, 114 have one or more input devices 109, 110, 112, 113, 115 and 116 which are used to monitor the testing environment of users of the client devices 108, 111 and 114. The particular input devices shown in FIG. 1 include a digital camera device 109, 112, 115 and an audio pickup device 110, 113 and 116. The digital camera device 109, 112, 115 may be, for example, a web camera or the like, and the audio pickup device 110, 113, 116 may be a microphone or the like. Other types of input devices may be used without departing from the spirit and scope of the present invention.

The digital camera devices 109, 112, 115 and audio pickup devices 110, 113, 116 are used to input signals to the client devices 108, 111 and 114 representing the visual and auditory aspects of the testing environments of the users of the client devices 108, 111 and 114. The input signals from the digital camera devices 109, 112, 115 and audio pickup devices 110, 113, 116 are input to the client devices 108, 111 and 114 which then transmit the input signals as data packets to the test administration system 103, and in particular server 104. The server 104 then routes the data packets to an appropriate proctor workstation 105-107 that is assigned to monitor the particular client device 108, 111, or 114, as will be described in more detail hereafter.

As mentioned above, the distributed data processing system 100 contains the network 102, which is the medium used to provide communications links between various devices and computers connected together within network data processing system 100. Network 102 may include connections, such as wire, wireless communication links, or fiber optic cables. Network 102 may further be comprised of more than one network of the same or different types. Thus, for example, the network 102 may include the Internet, local area networks (LANs), wide area networks (WANs), proprietary networks, wired or wireless telecommunication networks, and the like.

The client devices 108, 111, and 114 maybe, for example, personal computers or network computers. Client devices 108, 111, and 114 are clients to the central server 104 of the test administration system 103. Network data processing system 100 may include additional servers, clients, and other devices not shown.

In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. FIG. 1 is intended only as an example, and not as an architectural limitation for the present invention.

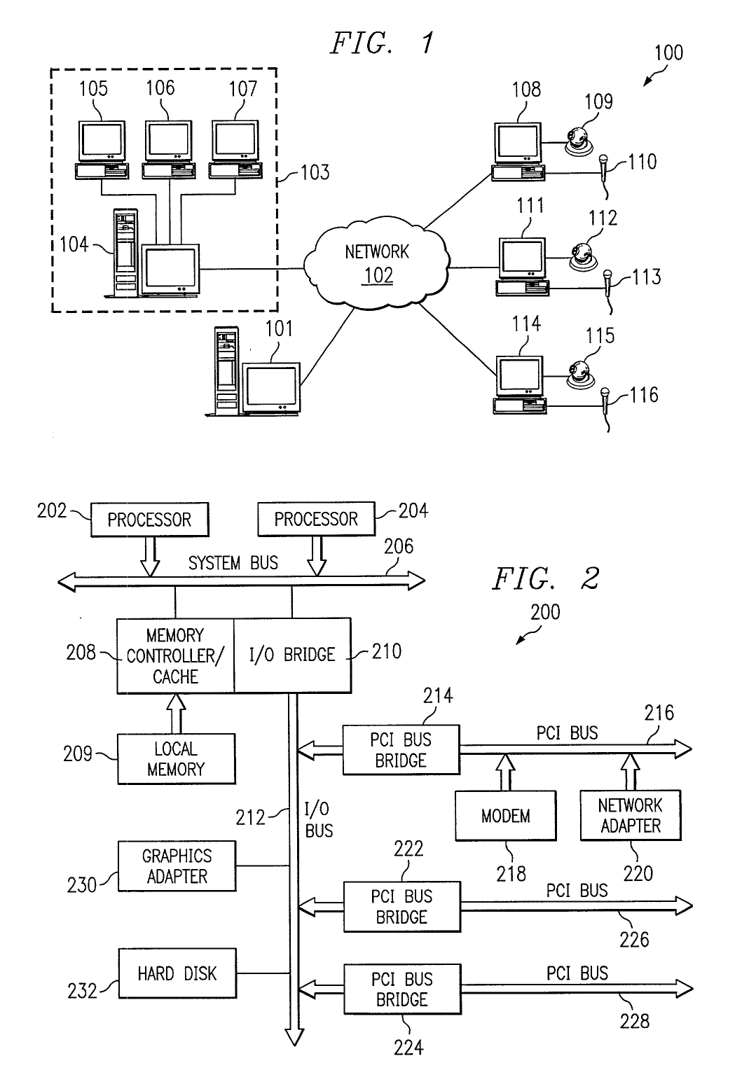

Referring to FIG. 2, a block diagram of a data processing system that may be implemented as a server, such as central server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards. Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

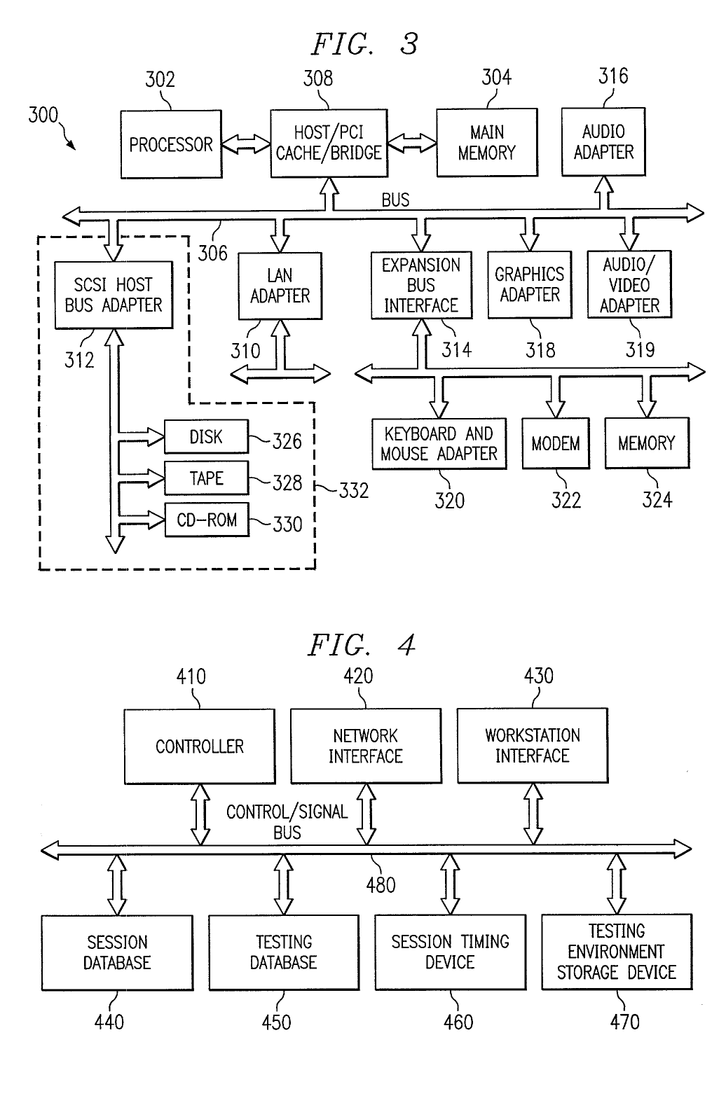

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

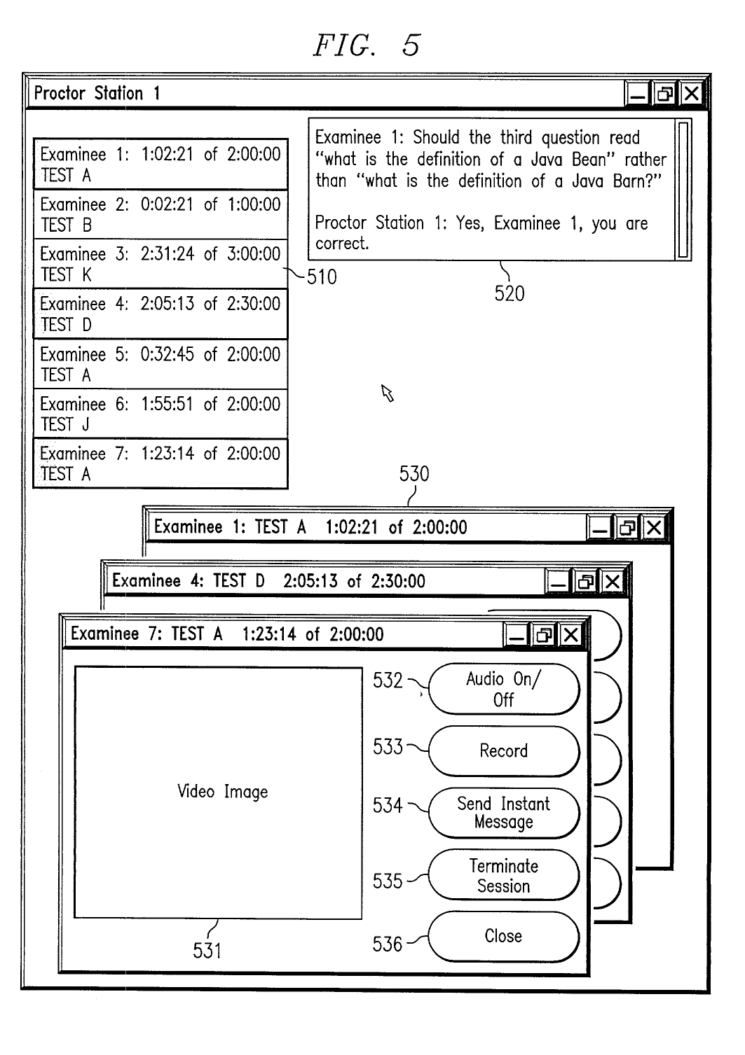

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance. FIG. 4 is an exemplary block diagram of the primary operational components of a central server of the test administration system 103. The primary operational components shown in FIG. 4 may be embodied as hardware components, software instructions, or a combination of hardware components and software instructions. In a preferred embodiment, the primary operational components are a combination of software instructions executed by a processor of the central server, such as processor 202 or 204, and hardware components, such as modems, network interfaces, storage devices, and the like.

As shown in FIG. 4, the primary operational components include a controller 410, a network interface 420, a workstation interface 430, a session database 440, a testing database 450, a session timing device 460, and a testing environment storage device 470. These components are in communication with one another via the control/signal bus 480. Although a bus architecture is shown in FIG. 4, the present invention is not limited to such and any architecture that facilitates the transfer data and control signals between the components 410-470 may be used without departing from the spirit and scope of the present invention.

The controller 410 controls the overall operation of the central server and orchestrates the operation of the other components 420-470 by sending control messages to these components 420-470 via the control/signal bus 480. The network interface 420 provides a communication pathway between the central server and the at least one network 102. Data packets from client devices are received via the network interface 420 and data packet messages are sent to the client devices via this network interface 420 under instruction by the controller 410.

The workstation interface 430 provides a communication pathway between the central server and one or more proctor workstations. Monitoring information, such as the data packets received from the client devices, is sent to an appropriate proctor workstation via the workstation interface 430. In addition, instructions and data may be received from the proctor workstations via the workstation interface 430 for processing by the controller 410 and, in some cases, forwarding to the client devices via the network interface 420.

The session database 440 stores information associated with a particular testing session of a particular client device. The session database 440 stores entries for each session that is currently active. When a user of a client device, for example, first logs onto the test administration system via his client device, a session id is associated with the client device. This session id is stored in the session database 440 along with any other pertinent information needed for administration of tests to the user of the client device. Such information may include the user's name, address, student id number, test identifier, and the like.

In addition, the session database 440 includes an indicator of the proctor workstation assigned to monitor the session. The particular proctor workstation assigned is determined by the controller 410 at initiation of the session. The assignment of the proctor workstation may be performed any reasonable manner. For example, the proctor workstation may be assigned based on relative current workloads of the various proctor workstations, a random selection, a type of test being administered during the session, or the like.

The session database 440 is also used as a means for correlating data packets received from client devices and send to client devices via the central server. Each data packet contains header information that includes the session identifier for the session to which the data packet belongs. From the session id of the data packet header, the appropriate proctor workstation or client device that is to receive the data packet may be determined. The data packet may then be routed to the proper receiving device based on this identification.

The testing database 450 stores the data representing the tests that are administered by the test administration system. The data in the testing database 450 may be used to generate tests to be administered to the various client devices. These tests may be administered in the form of applications, applets, hypertext markup language (HTML) web pages, or the like. The user of a client device may enter answers to test questions via the particular form in a manner generally known in the art. The correct answers to the various test questions may also be stored in the testing database 450 and used as a means for scoring the answers received from the user via the client device. Once the test is completed by the user, the final score for the user may be stored in a permanent memory location for use by the test developer system and/or may be provided to the user via the client device.

In addition, the testing database 450 may store an indication of the number of users to which the particular test was administered. This information may be used by a payment system to determine an amount to bill the test developer system operator for use of the test administration service of the test administration system. The session timing device 460 is used to time each of the currently active sessions being administered by the test administering system. The session timing device 460 determines a currently elapsed time of the test session, compares the currently elapsed time to a total time length of the administered test, and determines whether the test should be ended based on the comparison. In addition, the session timing device 460 may be used to timestamp video and audio data received from the client devices as well as test answer input received from the client devices. In this way, if a user is suspected of cheating on a test, the video, audio and input data may be correlated to determine whether an input was the result of unauthorized aide being provided to the user.

The testing environment storage device 470 is used to record the video and/or audio data of a user's testing environment during a session. The video and/or audio data may be recorded for the entire session or a portion of the session based on input from a human proctor of a proctor workstation. As mentioned above, the video and audio data may be time stamped in order to correlate the data later. The video and audio data may further be stored in association with a session id for the particular session.

In operation, a user of client device may log onto the central server by entering, for example, a universal resource locator (URL) of the test administration system central server using a web browser application in a manner generally known in the art. The user may be presented with a list of tests available and may select a test to take using an input mechanism associated with the client device and a web page downloaded to the client device, for example. Once the user selects a test to be administered, a session is established and a session id is assigned. In addition, a proctor workstation is assigned to monitor the user's testing environment while the user takes the test. The session entry is stored in the session database 440 and the test is retrieved from the testing database 450. The test is then downloaded to the user's client device via the network interface 420. The session timing device 460 is then initiated for the session and is used to time the test as well as provide time stamp information for video, audio and answer input data received from the client device. Video and/or audio input to the client device is forwarded to the central server and received by the controller 410 via the network interface 420. The video and/or audio data may then be forwarded to the proctor workstation via the workstation interface 430 and may be stored in the testing environment storage device 470. Routing of the video and/or audio data as well as storing of this data in the testing environment storage device 470 may be based on a comparison of the header information for the video and/or audio data to session information stored in the session database 440.

The human proctor may monitor the video and/or audio data via the proctor workstation and may be able to input instructions and messages via the proctor workstation. For example, the human proctor may input instructions to record the video and/or audio data, end a session, turn audio on/off, send an instant text message to the client device, and may select which sessions the human proctor wants to monitor, as will be described in greater detail hereafter. In addition, the human proctor may receive instant text messages from the user of the client device via the proctor workstation.

In addition, the human proctor may, in one exemplary embodiment, issue instructions to the client device to control the position of the video camera and/or audio pickup device in order to obtain a better indication of the testing environment. For example, the human proctor may issue an instruction to pan the video camera to the left, right, up, down, zoom in, zoom out, or the like. Such instructions may be issued using a joystick or other input device associated with the proctor workstation.

If the human proctor monitors the user's environment and suspects the user of cheating on the test based on the video and/or audio information received, the human proctor may issue an instant message to the user, record the video and/or audio data, and in more drastic instances termination the testing session. If the human proctor decides to record the video and/or audio data, the input received from the user may also be recorded and time stamped in order to determine what answers the user obtained unauthorized assistance on. This information may be used at a later time to invalidate the user's test score.

Once the test is completed, the user's score for the test may be permanently stored for use by the test developer system and may also be provided to the user for his/her own edification. Once the testing session terminates, the session entry in the session database 440 may be deleted. However, if the video and/or audio data was recorded during the session, the session entry may be retained for use in determining whether the user cheated on the test.

As mentioned above, the testing database 450 may also store information pertaining to the number of users that have taken the test. This information may be used by the controller 410 to generate a bill for the test developer system operator. Thus, in this way, the test developer system operator may be billed for the actual number of users that used the test administration services of the test administration system. Alternatively, the controller 410 may generate bills for each of the users based on information received from the users during an initial registration procedure as is generally known in the art. The bills generated by the controller 410 may be provided to the bill recipients via any known manner, including regular mail, electronic mail, or other electronic transmission means.

Thus, the present invention provides a mechanism by which a test may be administered and a testing environment may be monitored from a remote location. In addition, the present invention provides a mechanism by which a third party may be contracted to administer tests to client devices for a fee. The present invention allows a human proctor to monitor a plurality of test takers from a single workstation. A workstation interface for performing these monitoring tasks is described herein below.

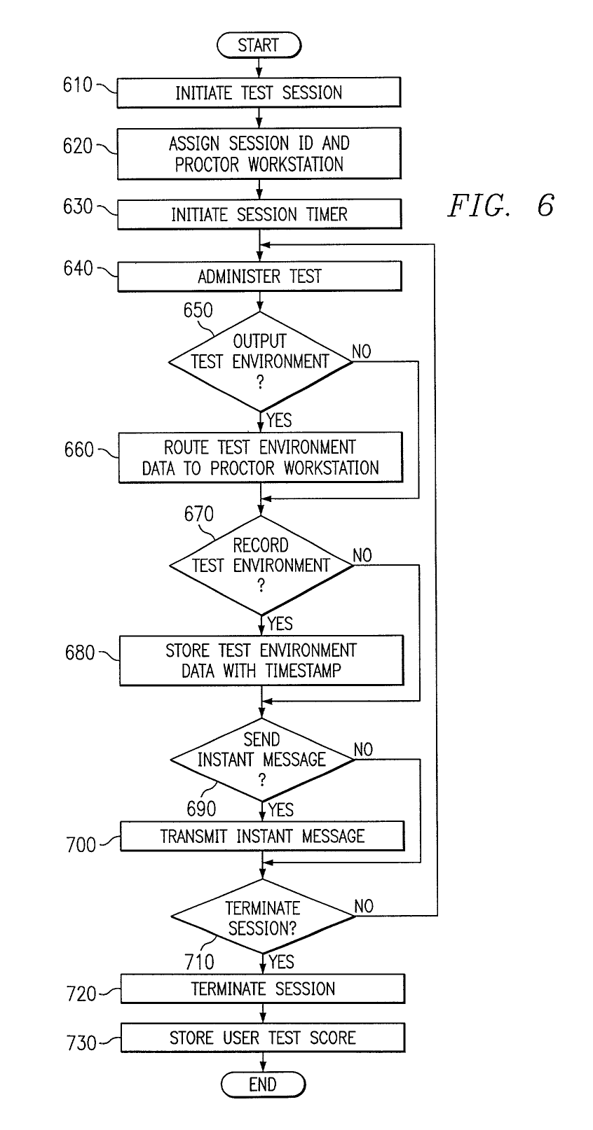

FIG. 5 is an exemplary diagram illustrating a workstation interface in accordance with one exemplary embodiment of the present invention. As shown in FIG. 5, the workstation interface includes a listing of currently active sessions 510, an instant text message box 520, and one or more windows 530 in which test environment information for a selected test session may be displayed.

The listing of currently active sessions 510 may include one or more entries for sessions that are currently active and are assigned to this particular proctor workstation. Each entry in the listing 510 may include an examinee identification, a currently elapsed time of the testing session, and an indicator of the test being administered. Other information may be displayed in addition to or in replacement of the information explicitly shown in FIG. 5 without departing from the spirit and scope of the present invention.

The human proctor may select sessions from the listing 510 which the human proctor wishes to monitor using a test environment window 530. Upon selection of a session, a test environment window 530 for the session is generated and the video and/or audio data being received from the client device is output to the proctor workstation.

The test environment window 530 includes a video image section 531 which displays the video information currently being received from the client device. This video information may be received, for example, as a data stream or the like. In addition, the audio data being streamed from a client device may be output using speakers or the like, for a currently selected environment window 530.

The environment window 530 further may include virtual buttons 532-536. These virtual buttons 532-536 may be used by the human proctor to input commands to initiate functions to be performed by the controller 410. For example, the virtual button 532 maybe used to cause the controller 410 to instruct that the audio data being received not be forwarded to the proctor workstation. The virtual button 533 may be used to instruction the controller 410 to start recording of video and audio data. The virtual button 534 may be used to open a text box for sending an instant message to the user of the client device. The virtual button 535 may be used to terminate a testing session and the virtual button 536 may be used to close an environment window.

The instant message text box 520 is used to display instant messages received from a client device and instant messages sent to a client device. In this way, the human proctor may review a text conversation being conducted between the human proctor and the user. One instant message text box 520 may be used for all client devices and users with designations being displayed before each message or separate instant message text boxes 520 may be generated for each session.

FIG. 6 is a flowchart outlining an exemplary operation of the present invention. As shown in FIG. 6, the operation starts with initiating a test session in response to a user's selection of a test to be taken (step 610). Upon initiation of a test session, a session id is assigned and a proctor workstation is assigned to monitor the session (step 620). In addition, any relevant information for monitoring and providing the test to the user may be stored in the session database.

Once the test session is initiated, a session timer is initiated (step 630) and the test is administered to the user (step 640). Thereafter, a determination is made as to whether the test environment data being received from the client device should be output to the proctor workstation (step 650). This determination may be made based on whether the human proctor has selected this session for monitoring and whether the human proctor has enabled or disabled audio output for this session, for example. If the test environment data is to be output to the workstation, the test environment data is routed to the appropriate proctor workstation based on information stored in the session database (step 660). If the test environment data is not to be output, the test environment data is not sent to the proctor workstation.

Next, a determination is made as to whether the test environment data should be recorded (step 670). This determination may be made based on whether or not the human proctor has instructed the controller that the test environment data for this session should be recorded. If so, the test environment data is stored in the environment database along with timestamp information (step 680). In addition, input from the client device may also be stored in association with the test environment data in the environment database. If the test environment data is not to be recorded, the test environment data is not stored in the environment database.

Thereafter, a determination is made as to whether an instant message is to be sent to either the proctor workstation or the client device (step 690). If so, the instant message is routed to the appropriate receiving device (step 700). Otherwise, no instant message is sent.

A determination is then made as to whether the session is to be terminated (step 710). If so, the session terminates (step 720), the user's test score is stored in permanent storage for use by the test developer system (step 730) and the operation ends. If not, the operation returns to step 640.

In addition to the above, if the embodiment is such that the client device is billed for use of the test administration service, a bill may be generated and transmitted to the client device. Moreover, a credit card account or other account type may be charged for providing the test administration service of the present invention.

If the embodiment is such that the test developer system operator is charged for use of the test administration service, information may be stored indicating the number of users to which a particular test was administered. This information may then be used to generate a bill to be paid by the test developer system operator.

Thus, the present invention provides a mechanism by which tests can be proctored from a remote location. Moreover, the present invention provides a mechanism for providing a test administration service by a third party who may bill for use of the test administration service.

The above embodiments assume that a human proctor monitors the environments of the test takers and is the one that determines whether a test taker is suspected of cheating. However, the present invention is not limited to such. Rather, the test administration system of the present invention may be provided with instructions for automatically monitoring the video and/or audio data received from the client devices to determine if cheating is suspected.

In such an embodiment, the video and/or audio data is analyzed as it is received from the client devices to determine if changes in the video and/or audio data are of a type that cheating is suspected. For example, the noise level and motion level in the audio and video data may be compared to previous audio and video data received to determine if a large change in this data is experienced. Such large changes may indicate that another person has entered the testing environment, or the test taker is involved in an activity that is not consistent with taking an on-line test.

If it is determined from the analysis of the video and/or audio data that suspicious behavior is happening within a testing environment, an alert may be generated on the proctor workstation and a window displaying the video and/or outputting the audio data may be automatically enabled so that the human proctor is made aware of the suspicious activity. In addition, recording of the video and/or audio data may be automatically started. The recorded video and/or audio data may be “flagged” to identify the video and/or audio data as having suspicious activity present.

Alternatively, rather than starting the recording of video and/or audio data only when suspicious activity is detected, the recording may be performed during other periods in which no suspicious activity is detected. In such an embodiment, the recording during non-suspicious activity periods may be at a reduced sampling rate while recording at times when suspicious activity is detected is performed at higher sampling rates. Other modifications to the embodiments described above will become apparent to those of ordinary skill in view of the above description and are intended to be within the spirit and scope of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

What is claimed is:

1. A method of monitoring a test environment, comprising:
administering a test to a remotely located user of a client device;
receiving test environment data from the client device, the test environment data representing a test environment of the remotely located user; and
outputting the test environment data to a proctor device such that a human proctor may monitor the test environment of the remotely located user.

2. The method of claim 1, further comprising billing a test developer for administration of the test to the remotely located user.

3. The method of claim 1, further comprising billing the remotely located user for administration of the test.

4. The method of claim 1, wherein the test environment data includes at least one of video and audio data.

5. The method of claim 1, further comprising recording the test environment data along with timestamp data.

6. The method of claim 1, further comprising sending an instant message to the client device.

7. The method of claim 1, further comprising receiving an instant message from the client device.

8. The method of claim 1, further comprising terminating administering the test in response to a command input by the human proctor.

9. The method of claim 1, further comprising storing a score for the test in a permanent storage.

10. The method of claim 1, wherein the test is developed by a test developer and wherein the method is implemented by a test administration system that is operated by a different entity from the test developer.

11. The method of claim 1, further comprising:
receiving a request for administration of the test to the remotely located user;
establishing a session identification for the administration of the test to the remotely located user; and
correlating the test environment data to the administration of the test to the remotely located user based on the session identification.

12. The method of claim 11, wherein the session identification includes a proctor device identifier, and wherein outputting the test environment data to the proctor device is based on the proctor device identifier.

13. The method of claim 1, further comprising:
storing an indicator of a number of test takers for the test; and
billing a test developer of the test based on the number of test takers for the test.

14. The method of claim 1, further comprising:
transmitting at least one instruction to the client device to thereby control a position of a video camera associated with the client device.

15. The method of claim 1, further comprising:
monitoring the test environment data for evidence of suspicious activity, wherein outputting the test environment data to a proctor device is performed in response to determining that evidence of suspicious activity is present.

16. The method of claim 5, further comprising:
monitoring the test environment data for evidence of suspicious activity, wherein recording the test environment data is performed in response to determining that evidence of suspicious activity is present.

17. The method of claim 5, further comprising:
monitoring the test environment data for evidence of suspicious activity, wherein recording the test environment data includes recording the test environment data at a first sample rate when evidence of suspicious activity is not present and recording the test environment data at a second sample rate when evidence of suspicious activity is present.

18. The method of claim 15, wherein monitoring the test environment data for evidence of suspicious activity includes comparing previously received test environment data to currently received test environment data to determine if a change in the test environment data indicates evidence of suspicious activity.

19. The method of claim 16, wherein monitoring the test environment data for evidence of suspicious activity includes comparing previously received test environment data to currently received test environment data to determine if a change in the test environment data indicates evidence of suspicious activity.

20. The method of claim 17, wherein monitoring the test environment data for evidence of suspicious activity includes comparing previously received test environment data to currently received test environment data to determine if a change in the test environment data indicates evidence of suspicious activity.

21. An apparatus for monitoring a test environment, comprising:
a controller; and
at least one interface coupled to the controller, wherein the controller administers a test to a remotely located user of a client device via the at least one interface, receives test environment data from the client device via the at least one interface, the test environment data representing a test environment of the remotely located user, and outputs the test environment data to a proctor device via the at least one interface, such that a human proctor may monitor the test environment of the remotely located user.

22. The apparatus of claim 21, wherein the controller bills a test developer for administration of the test to the remotely located user.

23. The apparatus of claim 21, wherein the controller bills the remotely located user for administration of the test.

24. The apparatus of claim 21, wherein the test environment data includes at least one of video and audio data.

25. The apparatus of claim 21, further comprising a storage device, wherein the controller records the test environment data along with timestamp data into the storage device.

26. The apparatus of claim 21, wherein the controller sends an instant message to the client device via the at least one interface.

27. The apparatus of claim 21, wherein the controller receives an instant message from the client device via the at least one interface.

28. The apparatus of claim 21, wherein the controller terminates administering the test in response to a command received from the proctor device via the at least one interface.

29. The apparatus of claim 21, further comprising a storage device, wherein the controller stores a score for the test in the storage device.

30. The apparatus of claim 21, wherein the test is developed by a test developer and wherein the apparatus is operated by a different entity from the test developer.

31. The apparatus of claim 21, wherein the controller receives a request for administration of the test to the remotely located user, establishes a session identification for the administration of the test to the remotely located user, and correlates the test environment data to the administration of the test to the remotely located user based on the session identification.

32. The apparatus of claim 31, wherein the session identification includes a proctor device identifier, and wherein the controller outputs the test environment data to the proctor device based on the proctor device identifier.

33. The apparatus of claim 21, further comprising a storage device, wherein the controller stores an indicator of a number of test takers for the test in the storage device and bills a test developer of the test based on the number of test takers for the test.

34. The apparatus of claim 21, wherein the controller transmits at least one instruction to the client device via the at least one interface to thereby control a position of a video camera associated with the client device.

35. The apparatus of claim 21, wherein the controller monitors the test environment data for evidence of suspicious activity, and wherein the controller outputs the test environment data to a proctor device in response to determining that evidence of suspicious activity is present.

36. The apparatus of claim 25, wherein the controller monitors the test environment data for evidence of suspicious activity, and wherein the controller records the test environment data in response to determining that evidence of suspicious activity is present.

37. The apparatus of claim 25, wherein the controller monitors the test environment data for evidence of suspicious activity, and wherein the controller records the test environment data at a first sample rate when evidence of suspicious activity is not present and records the test environment data at a second sample rate when evidence of suspicious activity is present.

38. The apparatus of claim 35, wherein the controller monitors the test environment data for evidence of suspicious activity by comparing previously received test environment data to currently received test environment data to determine if a change in the test environment data indicates evidence of suspicious activity.

39. The apparatus of claim 36, wherein the controller monitors the test environment data for evidence of suspicious activity by comparing previously received test environment data to currently received test environment data to determine if a change in the test environment data indicates evidence of suspicious activity.

40. The apparatus of claim 37, wherein the controller monitors the test environment data for evidence of suspicious activity by comparing previously received test environment data to currently received test environment data to determine if a change in the test environment data indicates evidence of suspicious activity.

41. A computer program product in a computer readable medium for monitoring a test environment, comprising:
first instructions for administering a test to a remotely located user of a client device;
second instructions for receiving test environment data from the client device, the test environment data representing a test environment of the remotely located user; and
third instructions for outputting the test environment data to a proctor device such that a human proctor may monitor the test environment of the remotely located user.
